(19) United States
(12) Patent Application Publication
(10) Pub. No.: US 2006/0114460 A1
(43) Pub. Date: Jun. 1, 2006

(54) Method and device for selecting shade of a colour coding ring

(76) Inventors: Philippe Boyer, Marseille (FR); Alain Mazuir, Marseille (FR)

Correspondence Address: YOUNG & THOMPSON, 745 SOUTH 23RD STREET, 2ND FLOOR, ARLINGTON, VA, 22202, US

(21) Appl. No.: 10/520,916

(22) PCT Filed: Jul. 11, 2003
(86) PCT No.: PCT/FR03/02207

§ 371 Date: Aug. 29, 2005

(30) Foreign Application Priority Data
Jul. 11, 2002 (FR) 02/08748

(51) Int. Cl. G01N 21/84; A61C 19/10; A61C 19/04; G01J 3/46; G01J 3/52

(52) U.S. Cl. 356/402; 356/408; 356/421; 433/215; 433/27; 433/29; 348/161

(57) ABSTRACT

A method and a device for determining the sample of a colour coding ring closest to the colour of at least one element of a patient's set of teeth (3). The method includes steps which consist in: with imaging elements having a video camera (1), inputting and freezing on the screen (7) a colour image (7a) of the set-of-teeth element (3), filming the colour coding ring and displaying on the screen (7) the image of at least one sample, such that the image is side by side with the frozen image (7a) of the set-of-teeth element, visually comparing the image (7a) of the set-of-teeth element (3) frozen on the screen (7) and the sample image.

The present invention relates to a method for selecting the shade of the sample of a colour coding ring (palette) closest to the real colour of a patient's tooth, as well as to a device for carrying out such a method.

It is known that the operation consisting in selecting, from a colour coding ring, a sample thereof of which the shade is the closest to that of a patient's tooth, is extremely delicate to carry out. One of the reasons of the difficulties of such an operation resides in particular in the fact that it is sometimes extremely difficult to detect by sight the shades of two neighbouring samples of the coding ring. This operation is all the more problematic as, most of the time, it is extremely difficult to position each sample of the coding ring correctly with respect to the patient's teeth and to illuminate the whole in uniform manner in order not to falsify the assessment.

The present invention has for its object to overcome this drawback by proposing a method and a device making it possible to effect such a selection rapidly, simply and efficiently.

The present invention thus has for its object a method for determining the sample of a colour coding ring (palette) closest to the colour of at least a part of at least one element of a patient's set of teeth, characterized in that it comprises the steps consisting, with the aid of imaging means comprising a video camera, in:
inputting and freezing on the screen a colour image of this set-of-teeth element,
filming the colour coding ring and displaying on the screen the image of at least one sample, so that this image lies side by side with the frozen image of the set-of-teeth element,
visually comparing the image of the set-of-teeth element frozen on the screen and the image of the sample.

So as to allow the user to compare the frozen image of the set-of-teeth element with the image of the sample visually, the image of the samples of the colour coding ring may be made to advance on the screen.

Furthermore, in order to polish up this comparison, it is also possible to freeze on the screen the image of the sample, which thus leaves the practitioner completely free to make this comparison calmly. It has been observed that the assessment made by the practitioner was further improved if the two images were arranged to be joined side by side without there being any separation therebetween.

In one form of embodiment of the invention, the value of the chrominance of the video camera will be increased with respect to the normal adjustment of the camera, during inputting of the image of the set-of-teeth element and filming of the colour coding ring. The value of the differences in chrominance (R-Y; B-Y) may also be increased.

It is also possible, according to the invention, to inhibit the means for automatically controlling the luminosity of the camera, as well as the chrominance. In this way it is avoided that these adjustments of the camera be disturbed by the outside lighting conditions.

The present invention also has for its object a device for determining the sample of a colour coding ring closest to the colour of at least a part of at least one element of a patient's set of teeth, of the type comprising a video camera, characterized in that it comprises:
means adapted to input and freeze on the screen a colour image of this set-of-teeth element,
means adapted to film the colour coding ring and to display on the screen the image of at least one sample thereof,
means adapted to display side by side on the same screen the frozen image of the set-of-teeth element and the filmed image of the sample.

This device may comprise means for freezing on the screen the image of the sample, as well as means adapted to dispose the image of the set-of-teeth element and the image of the sample, side by side and without separation.

A form of embodiment of the present invention will be described hereinafter by way of non-limiting example, with reference to the accompanying drawings, in which:

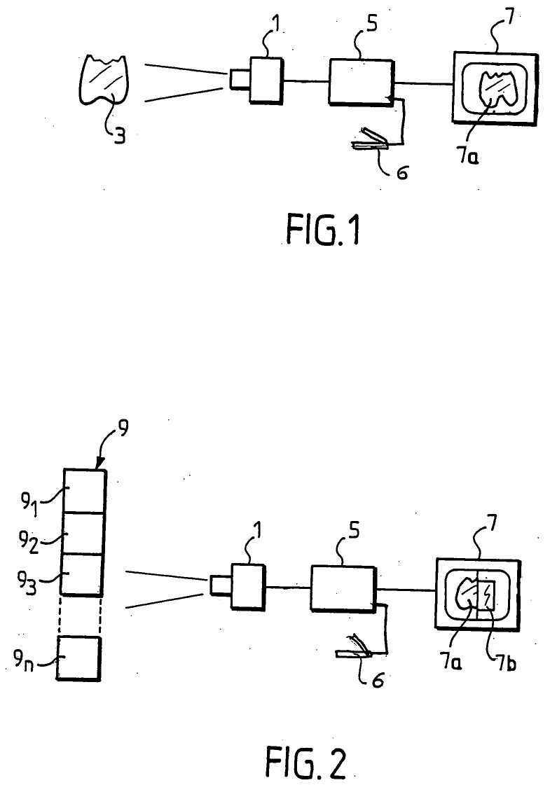

FIGS. 1 and 2 are schematic views of an installation showing two respective phases of the method according to the invention.

A form of embodiment of the present invention will be described hereinafter which has proved particularly advantageous, in particular by reason of the simplicity of its implementation.

According to the latter, and as shown in FIG. 1, a video camera 1 is employed, with which a tooth 3 whose colour it is desired to reproduce is filmed, and the video signal obtained, after processing in a conventional signal processing device 5, is sent to a video monitor 7. When the image obtained on the latter seems good to the practitioner, he/she acts via a control member such as for example a pedal 6, on the signal processing device 5 in order to freeze the image 7a of the tooth on the screen of the monitor 7, i.e. in order to immobilize it and conserve it.

By means of the same camera 1, equipped with the same signal processing device 5 and the same video monitor 7, there is made to advance, as shown in FIG. 2, under the lens of the camera 1, each of the samples 9₁, 9₂, 9₃ . . . 9ₙ of the colour coding ring 9 which is filmed, at the same time as the image 7b obtained is displayed on the video monitor 7 next to the image 7a of the tooth 3. When a first assessment leads the practitioner to consider that the values of the shades of the two images displayed on the screen are close, he/she actuates the pedal 6 of the signal processing device 5 again, which then freezes the image 7b of the sample of colour coding ring which is filmed on one half of the screen, as shown in the drawing. In the example shown in FIG. 1 (sic), there will thus be on the left half of the screen the image 7a of the patient's tooth and on the right half which is joined thereto the image 7b of the sample of the colour coding ring. The practitioner is thus in a position easily to compare by sight, under the best conditions possible and in precise manner, the shades of colour of the two images. If this examination does not satisfy him/her, he/she will have the possibility of resuming the scanning of the samples of the colour coding ring in order to find a new, more satisfactory one whose image he/she can freeze in order to be able to make an attentive examination thereof.

A sort of differential processing is thus effected which proves particularly interesting in that it makes it possible to eliminate in one go all the numerous parameters of adjustment of the video system, namely those inherent to the camera, its signal processing means as well as the video monitor 7 used.

It has thus been ascertained that the invention allows users having deficiencies at the level of the assessment of colours to determine nonetheless the appropriate shade with success.

In a particularly interesting variant of the present form of embodiment of the invention, using the signal processing means 5, the chrominance of the blue, green and red signals of the camera will be increased (with respect to an adjustment for normal use of the camera), and this by the same quantity for the respective shots of the tooth and of the elements 9ₙ of the colour coding ring. It is likewise possible to increase the differences in chrominance of the signals (Y being the luminance and R and B being the respective values of the red and blue signals, these differences in chrominance being under these conditions R-Y and B-Y).

It has thus been ascertained that, by increasing these respective values, it was particularly easy for the eye of the practitioner to distinguish precisely shades of colours between the neighbouring elements 9ₙ and 9ₙ₊₁ of the colour coding ring 9, which differences are totally unable to be assessed with the naked eye. The present form of embodiment of the invention thus makes it possible to some extent to amplify the differences in colours observed which, at the same time, notably increases the precision of the determination of the colours analyzed.

1. Method for determining the sample of a colour coding ring (palette) (9) closest to the colour of at least a part of at least one element (3) of a patient's set of teeth, characterized in that it comprises the steps consisting, with the aid of imaging means comprising a video camera (1), in:
inputting and freezing on the screen (7) a colour image (7a) of this set-of-teeth element (3),
filming the colour coding ring (9) and displaying on the screen (7) the image (7b) of at least one sample (9₁, 9₂, 9₃ . . . 9ₙ), so that this image (7b) lies side by side with the frozen image (7a) of the set-of-teeth element,
visually comparing the image (7a) of the set-of-teeth element (3) frozen on the screen (7) and the image (7b) of the sample (9₁, 9₂, 9₃ . . . 9ₙ).

2. Method according to claim 1, characterized in that samples (9₁, 9₂, 9₃ . . . 9ₙ) of the colour coding ring (9) are made to advance on the screen so as to allow the user to visually compare the frozen image (7a) of the set-of-teeth element (3) with the image (7b) of the sample.

3. Method according to claim 1, characterized in that the image (7b) of the sample is frozen on the screen (7) in order to facilitate comparison thereof with the image (7a) of the set-of-teeth element (3).

4. Method according to claim 1, characterized in that the two images (7a, 7b) are joined to each other without separation.

5. Method according to claim 1, characterized in that the value of the chrominance of the video camera (1) is increased with respect to the normal adjustment of the camera, during inputting of the image (7a) of the set-of-teeth element (3) and the filming of the colour coding ring (9).

6. Method according to claim 5, characterized in that, in addition, during inputting of the image (7a) of the set-of-teeth element (3) and filming of the colour coding ring (9), the value of the differences in chrominance (R-Y; B-Y) is increased with respect to the normal adjustment of the camera.

7. Method according to claim 1, characterized in that the means for automatically controlling the luminosity of the camera (1) are inhibited.

8. Method according to claim 1, characterized in that the means for automatically controlling the chrominance of the camera (1) are inhibited.

9. Device for determining the sample of a colour coding ring (9) closest to the colour of at least a part of at least one element (3) of a patient's set of teeth, of the type comprising a video camera (1), characterized in that it comprises:
means adapted to input and freeze on the screen (7) a colour image (7a) of this set-of-teeth element (3),
means adapted to film the colour coding ring (9) and to display on the screen the image (7b) of at least one sample thereof,
means adapted to display side by side on the same screen (7) the frozen image (7a) of the set-of-teeth element (3) and the filmed image (7b) of the sample.

10. Device according to claim 9, characterized in that it comprises means for freezing on the screen (7) the image (7b) of the sample.

11. Device according to claim 9, characterized in that it comprises means adapted to dispose the image (7a) of the set-of-teeth element (3) and the image (7b) of the sample, side by side and without separation.

12. Device according to claim 9, characterized in that it comprises means adapted to inhibit the means for automatically controlling the luminosity of the camera (1).

13. Device according to claim 9, characterized in that it comprises means adapted to inhibit the means for automatically controlling the chrominance of the camera (1).
